(19) United States
(12) Patent Application Publication
(10) Pub. No.: US 2008/0180860 A1
(43) Pub. Date: Jul. 31, 2008

(54) Magnetic thin film and magnetoresistance effect element

(75) Inventors: Migaku Takahashi, Sendai (JP); Masakiyo Tsunoda, Sendai (JP); Kojiro Komagaki, Kanagawa (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/998,361

(22) Filed: Nov. 29, 2007

(30) Foreign Application Priority Data
Jan. 31, 2007 (JP) 2007-22124

(51) Int. Cl. G11B 5/33

(52) U.S. Cl. 360/314; 360/319

(57) ABSTRACT

In the magnetic thin film, a magnetization direction of a ferromagnetic layer, e.g., a pinned layer, can be securely fixed. The magnetic thin film comprises: an antiferromagnetic layer; and the ferromagnetic layer. The antiferromagnetic layer is composed of a manganic antiferromagnetic material, and a manganese (Mn) layer is formed between the antiferromagnetic layer and the ferromagnetic layer.

### BACKGROUND OF THE INVENTION

The present invention relates to a magnetic thin film, in which an antiferromagnetic layer and a ferromagnetic layer are laminated, and a magnetoresistance effect element including the magnetic thin film, more precisely relates to a magnetic thin film, which is capable of securely fixing a magnetization direction of a ferromagnetic layer, and a magnetoresistance effect element including the magnetic thin film.

A magnetic head of a magnetic disk apparatus comprises: a write-head for writing data on a recording medium; and a read-head for reading data from the recording medium. The read-head includes a magnetoresistance effect element, whose resistance value is varied on the basis of magnetized signals recorded on the recording medium.

The magnetoresistance effect element has: a pinned layer whose magnetization direction is fixed; and a free magnetic layer (free layer), whose magnetization direction is varied on the basis of a magnetic field of the recording medium. A magnetization direction of the free layer is varied by magnetized signals from the recording medium, and the recorded data can be read on the basis of the variation of the resistance value, which is known by variation of relative angles of the magnetization direction of the free layer with respect to the magnetization direction of the pinned layer. The magnetoresistance effect element having such function is generally called a spin valve element.

Spin valve elements include a CIP (Current In Plane) type GMR (Giant MagnetoResistance) element and a CPP (Current Perpendicular to Plane) type TMR (Tunneling MagnetoResistance) element.

In each of the elements, magnetic films, nonmagnetic film, etc. are laminated. Many kinds of film structures have been employed. A basic film structure of a magnetoresistance effect film is shown in FIGS. 6A and 6B.

FIG. 6A shows the CIP type GMR element. A lower shielding layer 10, an insulating layer 11, a base layer 12, an antiferromagnetic layer 13, a first pinned layer 14a, an antiferromagnetic coupling layer 15, a second pinned layer 14b, an intermediate layer 16, a free layer 17, a cap layer 18 and an upper shielding layer 19 are laminated in this order from the bottom.

FIG. 6B shows the CPP type TMR element. A lower shielding layer 10, a base layer 12, an antiferromagnetic layer 13, a first pinned layer 14a, an antiferromagnetic coupling layer 15, a second pinned layer 14b, a tunnel barrier layer 20, a free layer 17, a cap layer 18 and an upper shielding layer 19 are laminated in this order from the bottom.

The antiferromagnetic layer 13 fixes a magnetization direction of the first pinned layer 14a by a switched connecting function. The antiferromagnetic coupling layer 15 securely fixes a magnetization direction of the second pinned layer 14b by an antiferromagnetic coupling function between the first pinned layer 14a and the second pinned layer 14b. The magnetization direction of the second pinned layer 14b is opposite to that of the first pinned layer 14a.

As shown in FIGS. 6A and 6B, in the GMR element, the second pinned layer 14b and the free layer 17 are laminated with the intermediate layer 16, which is composed of a nonmagnetic material; in the TMR element, the second pinned layer 14b and the free layer 17 are laminated with the tunnel barrier layer 20.

The variation of the resistance value of the magnetoresistance effect film is known by detecting the variation of the relative angle between the magnetization direction of the pinned layer and that of the free layer. Therefore, the magnetization direction of the pinned layer must be perfectly fixed. As described above, the magnetization direction of the pinned layer is securely fixed by providing the antiferromagnetic layer 13 or laminating the first pinned layer 14a and the second pinned layer 14b with the antiferromagnetic coupling layer 15.

However, fine magnetoresistance effect type read-heads have been developed with increasing recording density of recording media, and read-elements have been also miniaturized. However, a demagnetizing field to the miniaturized read-element makes the magnetization direction of the pinned layer skew with respect to the desired magnetization direction. The demagnetizing field negates a magnetic field. Intensity of the demagnetizing field is increased with miniaturizing the read-element.

If the magnetization direction of the pinned layer is varied by the demagnetizing field, output signals of the read-head will be asymmetric and pin-reverse will be occurred. To prevent the variation of the magnetization direction of the pinned layer of the miniaturized read-head, the magnetization direction of the pinned layer must be securely fixed.

To solve the problem, Applied Physics Letters vol. 84, No. 25,5222 (2004) discloses a technology of increasing unidirectional magnetic anisotropy of a laminated film including an antiferromagnetic film and a ferromagnetic film, wherein a heat treatment is performed for a long time, e.g., about 100 hours. By employing this technology, the unidirectional magnetic anisotropy of the laminated film including the antiferromagnetic film and the ferromagnetic film can be increased. However, the heat treatment takes a very long time, so production efficiency must be lowered.

### SUMMARY OF THE INVENTION

The present invention was conceived to solve the above described problems.

An object of the present invention is to provide a magnetic thin film, in which a magnetization direction of a ferromagnetic layer, e.g., a pinned layer of a magnetoresistance effect element, can be securely fixed, a magnetoresistance effect element having the magnetic thin film, and a magnetic head having the same.

To achieve the object, the present invention has following structures.

Namely, the magnetic thin film of the present invention comprises: an antiferromagnetic layer; and a ferromagnetic layer, wherein the antiferromagnetic layer is composed of a manganic antiferromagnetic material, and a manganese (Mn) layer is formed between the antiferromagnetic layer and the ferromagnetic layer.

The manganic antiferromagnetic material means an antiferromagnetic material including Mn, e.g., IrMn, PtMn, PdPtMn, PdMn.

Preferably, the antiferromagnetic layer is composed of IrMn, and the ferromagnetic layer is composed of CoFe.

The magnetoresistance effect element of the present invention comprises: a lower shielding layer; an upper shielding layer; and a magnetoresistance effect film being sandwiched between the lower and upper shielding layers, the magnetoresistance effect film including a pinned layer and a free layer, wherein an antiferromagnetic layer composed of a manganic antiferromagnetic material is provided under the pinned layer, and a manganese (Mn) layer is provided between the pinned layer and the antiferromagnetic layer.

Preferably, the pinned layer is constituted by a first pinned layer and a second pinned layer, which are laminated with an antiferromagnetic coupling layer. In a GMR element, the free layer may be laminated on the pinned layer with an intermediate layer; in a TMR element, the free layer may be laminated on the pinned layer with a tunnel barrier layer.

The magnetic head of the present invention comprises: a read-head; and a write-head, wherein the read-head has a magnetoresistance effect element, which comprises: a lower shielding layer; an upper shielding layer; and a magnetoresistance effect film being sandwiched between the lower and upper shielding layers, the magnetoresistance effect film including a pinned layer and a free layer, an antiferromagnetic layer composed of a manganic antiferromagnetic material is provided under the pinned layer, and a manganese (Mn) layer is provided between the pinned layer and the antiferromagnetic layer.

Preferably, the pinned layer is constituted by a first pinned layer and a second pinned layer, which are laminated with an antiferromagnetic coupling layer. In a GMR element of the magnetic head, the free layer may be laminated on the pinned layer with an intermediate layer; in a TMR element of the magnetic head, the free layer may be laminated on the pinned layer with a tunnel barrier layer.

In the magnetic thin film of the present invention, the Mn layer provided between the antiferromagnetic layer and the ferromagnetic layer securely fixes the magnetization direction of a ferromagnetic layer. Therefore, the magnetic thin film can be suitably used in magnetoresistance effect elements or memory elements.

In the magnetoresistance effect element having the magnetic thin film of the present invention, the magnetization direction of the pinned layer can be securely fixed, so that output characteristics of the magnetoresistance effect element can be improved. In case of the miniaturized magnetic head too, the magnetization direction of the pinned layer can be securely fixed, so that output characteristics of the magnetic head can be improved.

### BRIEF DESCRIPTION OF THE DRAWINGS

Embodiments of the present invention will now be described by way of examples and with reference to the accompanying drawings, in which:

FIG. 1A is an explanation view of a GMR element relating to the present invention;

FIG. 1B is an explanation view of a TMR element relating to the present invention;

FIG. 2 is a graph of unidirectional magnetic anisotropy with respect to film thickness of a Mn layer;

FIG. 3 is an explanation view of a sample film, which is used for measuring the unidirectional magnetic anisotropy;

FIG. 4 is an explanation view of saturation magnetization Ms and a shift magnetic field Hex;

FIG. 5 is a sectional view of a magnetic head having the magnetoresistance effect element of the present invention;

FIG. 6A is an explanation view of the conventional CIP type GMR element; and

FIG. 6B is an explanation view of the conventional CPP type TMR element.

### DETAILED DESCRIPTION OF THE EMBODIMENTS

Preferred embodiments of the present invention will now be described in detail with reference to the accompanying drawings.

### (Structure of Magnetoresistance Effect Element)

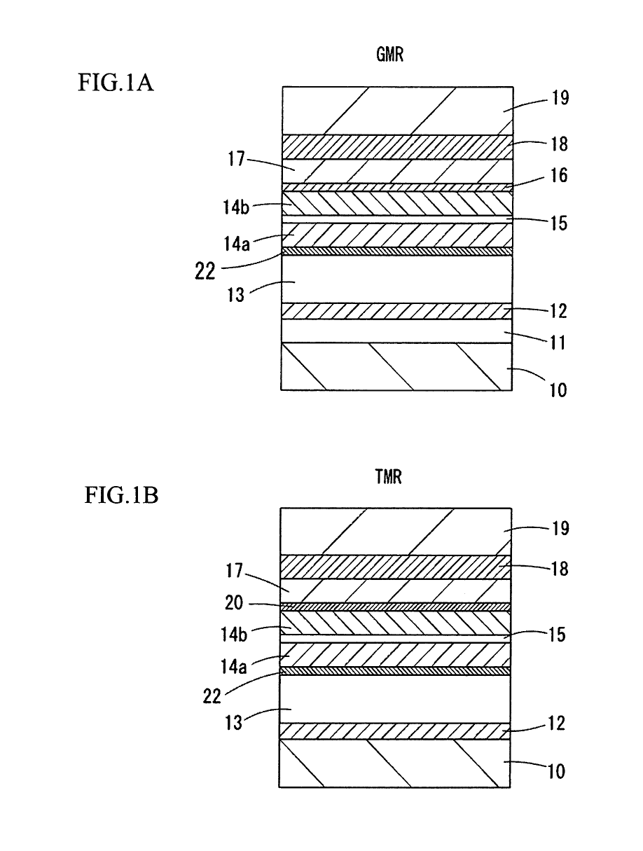

Embodiments of the magnetic thin film of the present invention are shown in FIGS. 1A and 1B. FIG. 1A is an explanation view of a CIP type GMR element; FIG. 1B is an explanation view of a CPP type TMR element.

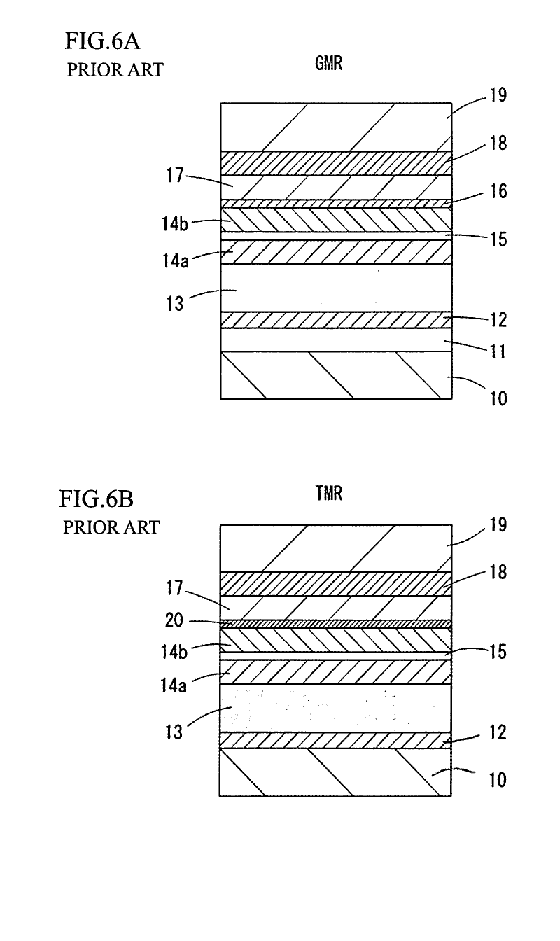

The characteristic point of the magnetoresistance effect elements shown in FIGS. 1A and 1B will be explained. Unlike the conventional magnetoresistance effect elements shown in FIGS. 6A and 6B, an antiferromagnetic layer 13 composed of a manganic antiferromagnetic material is used, and a manganese (Mn) layer 22 is provided between the antiferromagnetic layer 13 and a first pinned layer 14a. Conventionally, manganic materials have been used as ferromagnetic materials. The antiferromagnetic layer 13 is composed of the manganic antiferromagnetic material, e.g., IrMn, PtMn, PdPtMn, PdMn.

Various kinds of film structures may be used for magnetoresistance effect elements. Film structures of the magnetoresistance effect elements shown in FIGS. 1A and 1B will be explained.

In the GMR element shown in FIG. 1A, a lower shielding layer 10 is composed of a soft magnetic material, e.g., NiFe, and an insulating layer 11 is composed of, for example, alumina. A base layer 12 is a base of the antiferromagnetic layer 13 composed of the manganic antiferromagnetic material. The base layer 12 is a two-layer film composed of Ta/Ru.

The first pinned layer 14a and a second pinned layer 14b are composed of a ferromagnetic material, e.g., CoFe, CoFeB. An antiferromagnetic coupling layer 15 is composed of Ru.

An intermediate layer 16 provided between the second pinned layer 14b and a free layer 17 is composed of copper. The free layer 17 is a two-layer film composed of CoFe/NiFe. A cap layer 18 is a two-layer film composed of Ta/Ru and acts as a protection layer. An upper shielding layer 19 is composed of a soft magnetic material, e.g., NiFe, as well as the lower shielding layer 10.

In the TMR element shown in FIG. 1B, a tunnel barrier layer 20 is provided instead of the intermediate layer 16. The tunnel barrier layer 20 is composed of alumina or MgO. The tunnel barrier layer 20 is very thin, and a sense current is passed therethrough by tunnel effect.

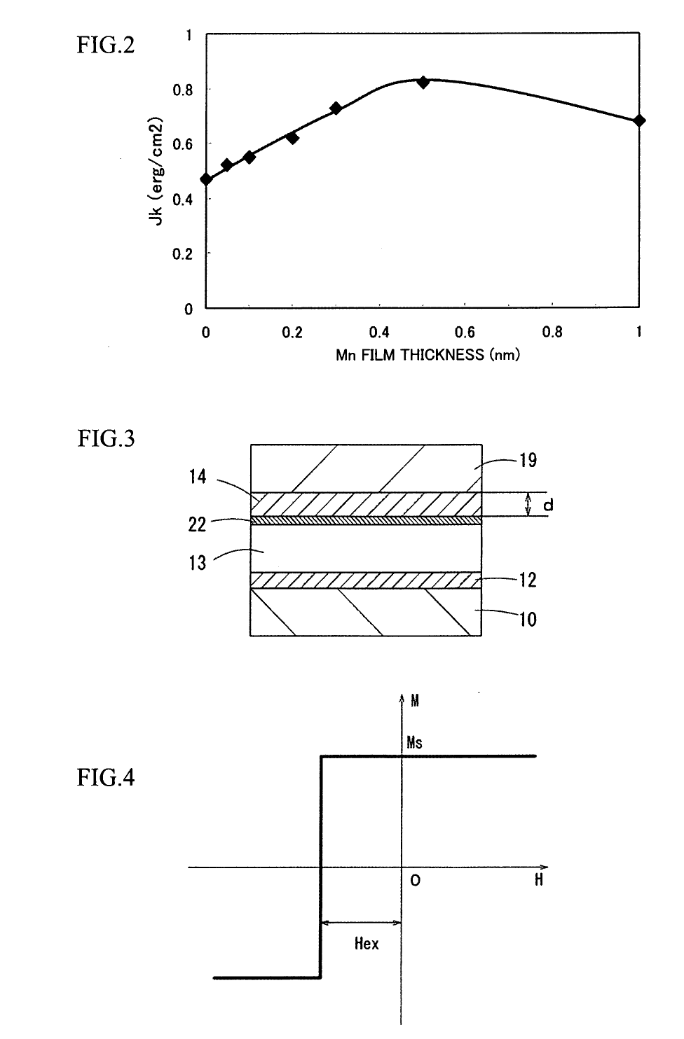

FIG. 2 is a graph of measured unidirectional magnetic anisotropy constants Jk (Jk=Ms×d×Hex, wherein Ms is saturation magnetization, d is film thickness and Hex is a shift magnetic field) of laminated films (samples), each of which includes a manganic antiferromagnetic layer and a Mn layer. The sample is shown in FIG. 3. The sample was constituted by: the lower shielding layer 10, the base layer 12, the antiferromagnetic layer 13, the Mn layer 22, the ferromagnetic layer 14 and the upper shielding layer 19. The lower shielding layer 10 and the upper shielding layer 19 were formed by sputtering NiFe.

The antiferromagnetic layer 13 had thickness of 10 nm and was formed by sputtering IrMn. The base layer 12 was a two-layer film composed of Ta/Ru.

The ferromagnetic layer 14 corresponds to a pinned layer of a magnetoresistance effect element. In the experiment, the ferromagnetic layer 14 had thickness of 4 nm and was formed by sputtering CoFe.

The thicknesses of the Mn layers of the samples were different. The unidirectional magnetic anisotropy constants Jk of the samples were measured.

Note that, the film thickness d of the formula for obtaining the unidirectional magnetic anisotropy constant Jk is the thickness of the ferromagnetic layer 14.

FIG. 4 shows the saturation magnetization Ms and the shift magnetic field Hex. FIG. 4 conceptually shows a magnetization curve when an external magnetic field is applied to the sample. As shown in FIG. 4, the saturation magnetization Ms and the shift magnetic field Hex are defined. According to the formula for obtaining the unidirectional magnetic anisotropy constant Jk, the unidirectional magnetic anisotropy constant Jk is increased when the shift magnetic field Hex is increased, so that a magnetization direction of the ferromagnetic layer can be securely fixed.

FIG. 2 shows the measured unidirectional magnetic anisotropy constants Jk of the samples, in which the thicknesses of the Mn layers 22 were different. Note that, in case of the thickness of the Mn layer=0 nm, the sample had no Mn layer 22. According to the results shown in FIG. 2, the measured unidirectional magnetic anisotropy constants Jk of the samples were varied within 0.45-0.82 (erg/cm²) by changing the thicknesses of the Mn layers 22. In comparison with the sample having no Mn layer 22, the measured unidirectional magnetic anisotropy constants Jk of the samples having the Mn layers 22 were increased. According to the graph, the measured unidirectional magnetic anisotropy constant Jk was maximized when the thickness of the Mn layer 22 was about 0.5 nm.

The used samples had the film structure shown in FIG. 3, and they were annealed at temperature of 280° C. for an hour.

According to the experiment, the unidirectional magnetic anisotropy constant Jk of the ferromagnetic layer 14 can be increased by providing the Mn layer 22 in a boundary surface between the antiferromagnetic layer 13 and the ferromagnetic layer 14. The unidirectional magnetic anisotropy constant Jk of the sample, in which the Mn layer 22 was provided between the antiferromagnetic layer 13 and the ferromagnetic layer 14, was twice as great as that of the sample having no Mn layer 22, but this improvement will be capable of securely fixing the magnetization direction of the ferromagnetic layer 14. Each of the samples was annealed for an hour after a laminating process. Namely, the annealing can be performed for a short time, so that production efficiency can be improved.

By employing the above described film structure, the magnetization direction of the ferromagnetic layer 14 can be securely fixed or the unidirectional magnetic anisotropy constant Jk can be increased. The reason can be that a spin structure of the antiferromagnetic layer 13 is varied in the vicinity of the boundary surface between the antiferromagnetic layer 13 and the ferromagnetic layer 14 by providing the Mn layer 22, so that the switched connection between the antiferromagnetic layer 13 and the ferromagnetic layer 14 can be strengthened, we think. The Mn layer 22 acts without reference to kinds of the antiferromagnetic material constituting the antiferromagnetic layer 13, and other manganic antiferromagnetic materials, e.g., PtMn, PdPtMn, PdMn, can be used as well as IrMn. Note that, IrMn, PtMn, PdPtMn and PdMn have the antiferromagnetism by adding Mn.

In the sample shown in FIG. 3, the antiferromagnetic layer 13, the Mn layer 22 and the ferromagnetic layer 14 are provided between the lower shielding layer 10 and the upper shielding layer 19. The film structure can be applied to the film structure of the magnetoresistance effect elements shown in FIGS. 1A and 1B. Namely, in each of the magnetoresistance effect elements shown in FIGS. 1A and 1B, the Mn layer 22 is provided in the boundary surface between the antiferromagnetic layer 13 and the first pinned layer 14a, which is the ferromagnetic layer. Therefore, the magnetization direction of the first pinned layer 14a can be securely fixed, and the magnetization direction of the second pinned layer 14b too can be securely fixed by the antiferromagnetic coupling layer 15.

The structure of the magnetic thin film can be applied to not only the magnetoresistance effect element having the pinned layer constituted by the first pinned layer 14a and the second pinned layer 14b but also the magnetoresistance effect element having a single pinned layer. The structure of the magnetic thin film is capable of securely fixing the magnetization direction of the pinned layer, so it can be applied to the both of the CIP type magnetoresistance effect element and the CPP type magnetoresistance effect element.

The structure of the magnetic thin film may be applied to not only the magnetoresistance effect element of the magnetic head but also memory elements, e.g., MRAM (Magnetoresistive Random Access Memory). In the MRAM, a pinned layer and a free layer sandwich an insulating layer, and magnetization direction of the free layer, which is varied by applying an external magnetic field, is used as a memory. In this case, the structure of the magnetic thin film is formed on the pinned layer side, so that the magnetization direction of the pinned layer can be fixed and characteristics of the memory element can be improved.

### (Magnetic Head)

A high quality magnetic head can be realized by applying the magnetoresistance effect element having the magnetic thin film to a read-head of the magnetic head.

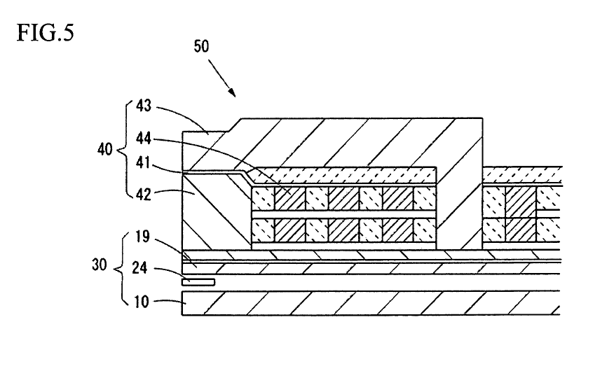

An embodiment of the magnetic head including the magnetoresistance effect element is shown in FIG. 5. The magnetic head 50 comprises a read-head 30 and a write-head 40. In the read-head 30, a read-element 24 constituted by the magnetoresistance effect film, which comprises the antiferromagnetic layer 13, the first pinned layer 14a, the second pinned layer 14b, the free layer 17, etc., is formed between the lower shielding layer 10 and the upper shielding layer 19.

The write-head 40 has a lower magnetic pole 42 and an upper magnetic pole 43, and a write-gap 41 is formed therebetween. A coil 44 for writing data is provided.

The magnetic head 50 is attached to a head slider, which writes data on and reads data from a recording medium. The head slider is mounted onto a head suspension of a magnetic disk apparatus. When the recording medium is rotated, the head slider is floated from a surface of the recording medium and data can be written on and read from the recording medium.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetic thin film,
comprising:
an antiferromagnetic layer; and
a ferromagnetic layer,
wherein said antiferromagnetic layer is composed of a manganic antiferromagnetic material, and
a manganese (Mn) layer is formed between said antiferromagnetic layer and said ferromagnetic layer.

2. The magnetic thin film according to claim 1,
wherein said antiferromagnetic layer is composed of IrMn, and
said ferromagnetic layer is composed of CoFe.

3. A magnetoresistance effect element,
comprising:
a lower shielding layer;
an upper shielding layer; and
a magnetoresistance effect film being sandwiched between said lower and upper shielding layers, said magnetoresistance effect film including a pinned layer and a free layer,
wherein an antiferromagnetic layer composed of a manganic antiferromagnetic material is provided under the pinned layer, and
a manganese (Mn) layer is provided between the pinned layer and the antiferromagnetic layer.

4. The magnetoresistance effect element according to claim 3,
wherein the pinned layer is constituted by a first pinned layer and a second pinned layer, which are laminated with an antiferromagnetic coupling layer.

5. The magnetoresistance effect element according to claim 3,
wherein the free layer is laminated on the pinned layer with an intermediate layer.

6. The magnetoresistance effect element according to claim 3,
wherein the free layer is laminated on the pinned layer with a tunnel barrier layer.

7. A magnetic head,
comprising:
a read-head; and
a write-head,
wherein said read-head has a magnetoresistance effect element, which comprises: a lower shielding layer; an upper shielding layer; and a magnetoresistance effect film being sandwiched between the lower and upper shielding layers, the magnetoresistance effect film including a pinned layer and a free layer,
an antiferromagnetic layer composed of a manganic antiferromagnetic material is provided under the pinned layer, and
a manganese (Mn) layer is provided between the pinned layer and the antiferromagnetic layer.

8. The magnetic head according to claim 7,
wherein the pinned layer is constituted by a first pinned layer and a second pinned layer, which are laminated with an antiferromagnetic coupling layer.

9. The magnetic head according to claim 7,
wherein the free layer is laminated on the pinned layer with an intermediate layer.

10. The magnetic head according to claim 7,
wherein the free layer is laminated on the pinned layer with a tunnel barrier layer.
